(19) United States
(12) Patent Application Publication
(10) Pub. No.: US 2009/0305109 A1
(43) Pub. Date: Dec. 10, 2009

(54) Fuel Cell Device

(75) Inventors: Toshihiko Nonobe, Tokyo (JP); Noriyuki Takada, Tokyo (JP)

Correspondence Address: BACON & THOMAS, PLLC, 625 SLATERS LANE, FOURTH FLOOR, ALEXANDRIA, VA, 22314-1176, US

(73) Assignee: KABUSHIKIKAISHA EQUOS RESEARCH, Tokyo (JP)

(21) Appl. No.: 12/224,435

(22) PCT Filed: Feb. 27, 2007
(86) PCT No.: PCT/JP2007/053665

§ 371 Date: Feb. 9, 2009

(30) Foreign Application Priority Data
Feb. 27, 2006 (JP) 2006-049524

(51) Int. Cl. H01M 8/10

(52) U.S. Cl. 429/32

(57) ABSTRACT

A portion of a fuel electrode corresponding to a portion in a fuel gas flow path where water accumulates is made to contain no catalyst, thus preventing abnormal reaction from occurring, and consequently enabling sure prevention of degradation of the fuel electrode and reduction in fuel cell performance. For that purpose, in a fuel cell device, a fuel cell having an electrolyte layer interposed between the fuel electrode and an oxygen electrode includes a cell module laminated so as to interpose a separator formed with the fuel gas flow path along the fuel electrode, and a fuel gas flows substantially perpendicularly to the direction of gravity in the fuel gas flow path. The fuel electrode includes a catalyst-absent portion which contains no catalyst, provided in a portion corresponding to a water-accumulating portion in which water is accumulated, in the fuel gas flow path.

### TECHNICAL FIELD

The present invention relates to a fuel cell device.

### BACKGROUND ART

Heretofore, because of having a high power generation efficiency and emitting no hazardous substances, a fuel cell has been put to practical use as a power generating device for industrial and household use, or as a source of power for an artificial satellite or a spacecraft, and in recent years, the development of fuel cells is being pursued as a source of power for a vehicle such as a passenger vehicle, a bus, a truck, a riding cart, or a luggage cart. Besides, although the fuel cell may be embodied as an alkaline fuel cell (AFC), a phosphoric acid fuel cell (PAFC), a molten carbonate fuel cell (MCFC), a solid oxide fuel cell (SOFC), or a direct methanol fuel cell (DMFC), the commonly used fuel cell is a polymer electrolyte membrane fuel cell (PEMFC).

In this case, a solid polymer electrolyte membrane is interposed between two gas diffusion electrodes to be bonded to form a single unit. Then, when hydrogen gas serving as a fuel is supplied onto the surface of one of the gas diffusion electrodes serving as a fuel electrode (anode), the hydrogen is dissociated into hydrogen ions (protons) and electrons, and the hydrogen ions permeate through the solid polymer electrolyte membrane. In addition, when air serving as an oxidizing agent is supplied onto the surface of the other of the gas diffusion electrodes serving as an oxygen electrode (cathode), oxygen in the air is combined with the hydrogen ions and electrons to form water. Thus, an electromotive force is generated by such an electrochemical reaction.

Besides, because both sides of the solid polymer electrolyte membrane need to be maintained in wet condition in the case of the polymer electrolyte membrane fuel cell, water is supplied onto each of the fuel electrode side and the oxygen electrode side. In this case, the water moves as proton-carrying water from the fuel electrode side to the oxygen electrode side, and moves as back-diffusing water from the oxygen electrode side to the fuel electrode side.

It is known that when the amount of the back-diffusing water is increased, a flow path for the hydrogen gas is locally blocked by water on the fuel electrode side, resulting in a reduction in fuel cell performance or degradation of the fuel electrode. As a result, technologies have been proposed in which a conductive material formed with a mesh is arranged in the hydrogen gas flow path between a separator and the fuel electrode so that the water is appropriately diffused (refer, for example, to Patent Document 1).

### [Patent Document 1]

Japanese Patent Application Publication No. JP-A-2005-209470

### DISCLOSURE OF THE INVENTION

### Problem to be Solved by the Invention

However, because the related art fuel cell device does not have means to drain the water accumulated in the hydrogen gas flow path, there have been cases in which a part of the fuel electrode is covered by the water when the amount of the water accumulated in the hydrogen gas flow path increases, resulting in the occurrence of an abnormal reaction to deteriorate the fuel electrode.

In order to solve the problem of the related art fuel cell device, it is an object of the present invention to provide a fuel cell device that has a fuel electrode that contains no catalyst in the portion corresponding to the part of the hydrogen gas flow path in which the water is accumulated, thus preventing the abnormal reaction from occurring so as to be capable of ensuring the prevention of the fuel electrode deterioration and of the reduction in fuel cell performance.

### Means for Solving the Problem

For that purpose, in a fuel cell device of the present invention, a fuel cell having an electrolyte layer interposed between a fuel electrode and an oxygen electrode includes a cell module laminated so as to interpose a separator formed with a fuel gas flow path along the fuel electrode, and a fuel gas flows substantially perpendicularly to the direction of gravity in the fuel gas flow path. The fuel electrode includes a catalyst-absent portion which contains no catalyst, provided in a portion corresponding to a water-accumulating portion in which water is accumulated, in the fuel gas flow path.

In addition, in another fuel cell device of the present invention, the water-accumulating portion is an area originating at a lower part in the fuel gas flow path and extending in the direction in which the fuel gas flows.

Furthermore, in still another fuel cell device of the present invention, the catalyst-absent portion has water repellency.

### EFFECTS OF THE INVENTION

According to the present invention, in a fuel cell device, a fuel cell having an electrolyte layer interposed between a fuel electrode and an oxygen electrode includes a cell module laminated so as to interpose a separator formed with a fuel gas flow path along the fuel electrode, and a fuel gas flows substantially perpendicularly to the direction of gravity in the fuel gas flow path. The fuel electrode includes a catalyst-absent portion which contains no catalyst, provided in a portion corresponding to a water-accumulating portion in which water is accumulated, in the fuel gas flow path.

In this case, because no abnormal reaction occurs in the portion corresponding to the water-accumulating portion of the fuel electrode, deterioration of the fuel electrode and reduction in fuel cell performance can be surely prevented.

In addition, in another fuel cell device, the water-accumulating portion is an area originating at a lower part in the fuel gas flow path and extending in the direction in which the fuel gas flows.

In this case, because the catalyst-absent portion is also formed at the lower part of the fuel electrode, the formation can be easily achieved by a method of, for example, masking.

Furthermore, in still another fuel cell device, the catalyst-absent portion has water repellency.

In this case, because the catalyst-absent portion does not soak up water, the water accumulated in the water-accumulating portion is prevented from rising.

### BRIEF DESCRIPTION OF THE DRAWINGS

FIG. 1 shows perspective views of reaction electrodes of a unit cell according to an embodiment of the present invention.

FIG. 2 shows views illustrating a fuel cell stack and an air supply fan of a fuel cell device mounted on a vehicle according to the embodiment of the present invention.

FIG. 3 is a schematic perspective view showing a structure of the fuel cell stack according to the embodiment of the present invention.

FIG. 4 is a schematic top view showing the structure of the fuel cell stack according to the embodiment of the present invention.

FIG. 5 shows schematic perspective views illustrating structures of cell modules according to the embodiment of the present invention.

FIG. 6 shows schematic perspective views illustrating flows of hydrogen gas in the cell modules according to the embodiment of the present invention.

FIG. 7 is a diagram showing a hydrogen gas flow path on the fuel electrode side of a separator according to the embodiment of the present invention.

FIG. 8 shows diagrams illustrating a method for manufacturing the unit cell according to the embodiment of the present invention.

### DESCRIPTION OF THE REFERENCE NUMERALS

11 FUEL CELL STACK
21 CELL MODULE
22 SEPARATOR
26 WATER-ACCUMULATING PORTION
31 SOLID POLYMER ELECTROLYTE MEMBRANE
34B CATALYST-ABSENT PORTION

### BEST MODES FOR CARRYING OUT THE INVENTION

An embodiment according to the present invention will be described in detail below with reference to the accompanying drawings.

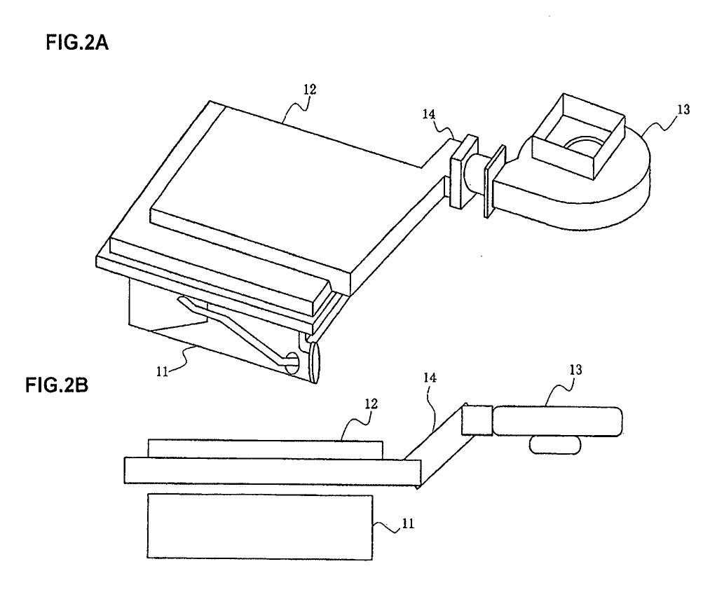

FIG. 2 shows views illustrating a fuel cell stack and an air supply fan of a fuel cell device mounted on a vehicle according to the embodiment of the present invention. Note that FIG. 2A is a perspective view, and FIG. 2B is a schematic perspective view.

In the drawings, reference numeral 11 denotes a fuel cell stack serving as a fuel cell (FC) device, which is used as a source of power for a vehicle such as a passenger vehicle, a bus, a truck, a riding cart, or a luggage cart. Here, because the vehicle is provided with a number of accessories, such as lighting devices, a radio, and power windows, that consume electricity used even while the vehicle is stopped, and also because the vehicle has a wide variety of driving patterns to require an extremely wide output range of the power source, it is desirable to use the fuel cell stack 11 serving as a power source together with a secondary battery or a capacitor serving as electrical storage means, which is not shown.

In addition, although the fuel cell stack 11 may be of an alkaline type, a phosphoric acid type, a molten carbonate type, a solid oxide type, a direct methanol type, or the like, it is preferable to be a polymer electrolyte membrane fuel cell.

Note that the fuel cell stack 11 is even more preferable to be a so-called proton exchange membrane fuel cell (PEMFC) or a proton exchange membrane (PEM) type fuel cell, in which hydrogen gas serves as a fuel gas, that is, an anode gas, and oxygen or air serves as an oxidizing agent, that is, a cathode gas. Here, the PEM type fuel cell is generally composed of a stack in which a plurality of cells are connected in series, where each cell combines a separator with a catalyst and electrodes on both sides of an electrolyte layer through which ions, such as protons, permeate.

In this embodiment, the fuel cell stack 11 has a plurality of cell modules 21, which will be described later. The cell module 21 is structured by stacking, in the direction of sheet thickness, a plurality of sets, each of which includes a unit cell (membrane electrode assembly, or MEA) serving as a fuel cell and a later-described separator 22 which electrically connects the unit cells with each other and separates between a flow path for the hydrogen gas serving as an anode gas and a flow path for air serving as a cathode gas, both gases being introduced into the unit cell. Note that in the cell module 21, the unit cells and the separators 22 are stacked in a plurality of layers, so that the unit cells are disposed at predetermined intervals. In this case, the cell modules 21 are connected with each other so as to conduct electricity and so that the fuel gas flow path, that is the hydrogen gas flow path, is continuously formed.

Moreover, as described later, the unit cell is composed of a solid polymer electrolyte membrane 31 serving as an electrolyte layer and reaction electrodes 34 provided on both sides of the solid polymer electrolyte membrane 31. Note that one of the reaction electrodes 34 functions as an oxygen electrode, that is, an air electrode, whereas the other functions as a fuel electrode, and the air electrode and the fuel electrode have virtually the same structure as each other. In addition, as described later, the reaction electrode 34 is composed of an electrode diffusion layer 33 made of an electrically conductive material that passes and diffuses the hydrogen or air, that is, a reaction gas, and a catalyst layer 32 containing a catalytic substance that is formed on the electrode diffusion layer 33 and supported by the contact with the solid polymer electrolyte membrane 31. The reaction electrode 34 also has: an air electrode side collector serving as a mesh-shaped collector that contacts with the electrode diffusion layer 33 on the air electrode side of the unit cell to collect power and that is formed with a number of openings to pass a mixed flow of air and water; and a fuel electrode side collector serving as a mesh-shaped collector that contacts with the electrode diffusion layer 33 on the fuel electrode side of the unit cell to conduct electric current outward.

Water moves in the unit cell. In this case, when hydrogen gas is supplied as the fuel gas, that is, the anode gas, in a fuel chamber formed on the fuel electrode side of the separator 22, the hydrogen is dissociated into hydrogen ions and electrons, and the hydrogen ions pass through the solid polymer electrolyte membrane 31 accompanied by proton-carrying water. In addition, using the air electrode as a cathode, when air is supplied as the oxidizing agent, that is, the cathode gas, in an oxygen chamber serving as an air flow path formed on the air electrode side of the separator 22, the oxygen in the air is combined with the hydrogen ions and the electrons to form water. Note that the water passes through the solid polymer electrolyte membrane 31 as back-diffusing water and moves into the fuel chamber. Here, the back-diffusing water is the water that is formed in the oxygen chamber serving as an air flow path, diffuses in the solid polymer electrolyte membrane 31, and passes through the solid polymer electrolyte membrane 31 in the opposite direction to that of the hydrogen ions to penetrate to reach the fuel chamber.

The figure shows a device that supplies the air serving as an oxidizing agent to the fuel cell stack 11. In this case, the air is pulled by an air supply fan 13 serving as an oxidizing agent supply source through an unshown air filter, and supplied from the air supply fan 13 through an air supply line 14 and an air intake manifold 12 to the oxygen chamber of the fuel cell stack 11, that is, the air flow path. In this case, the pressure of the supplied air is a normal pressure in the vicinity of atmospheric pressure. Note that any kind of fan can be used as the air supply fan 13 if it can pull and discharge air. In addition, any kind of filter can be used as the air filter if it can remove dust, impurities, and the like contained in the air. Note that oxygen can be used in place of air, as the oxidizing agent. Then, the air exhausted from the air flow path is discharged into atmosphere through an exhaust manifold, which is not shown. In the example shown in the figure, the air flows in the fuel cell stack 11 from top to bottom of FIG. 2B.

In addition, in the air supply line 14, there can be arranged a water supply nozzle for supplying water by spraying it into the air that is supplied to the air flow path to maintain the air electrode serving as an oxygen electrode of the fuel cell stack 11 in a wet condition. Moreover, at the end of the exhaust manifold, a condenser can be arranged for condensing and removing the moisture in the air that is discharged from the fuel cell stack 11. In this case, it is desirable that the water condensed by the condenser is collected in a water tank, which is not shown. Then, by supplying the water in the tank to the water supply nozzle, the water can be recycled to be reused without being wasted.

On the other hand, the hydrogen gas serving as a fuel gas is supplied from unshown fuel storage means composed of a container containing a hydrogen storage alloy, a container containing hydrogen storing liquid such as decalin, a hydrogen gas cylinder, or the like, through a fuel supply line, to an inlet of the fuel gas flow path of the fuel cell stack 11. Then, the hydrogen gas exhausted as an unreacted component from an outlet of the fuel gas flow path of the fuel cell stack 11 is discharged to the outside of the fuel cell stack 11 through a fuel discharge line, which is not shown. Note that it is desirable that a water collection drain tank is arranged in the fuel discharge line to collect the water separated from the exhausted hydrogen gas. This allows the hydrogen gas, which is discharged from the water collection drain tank after separating the water, to be collected and supplied to the fuel gas flow path of the fuel cell stack 11 to be reused.

Next, a structure of the fuel cell stack 11 will be described in detail below.

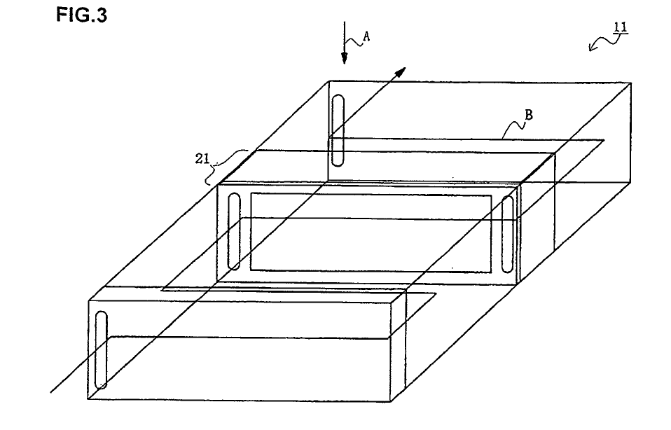

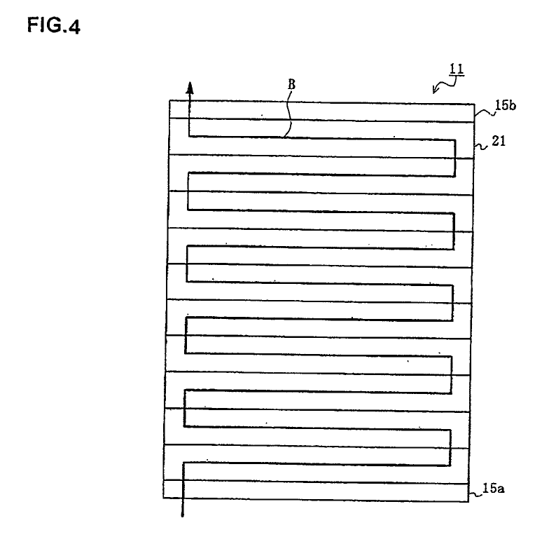

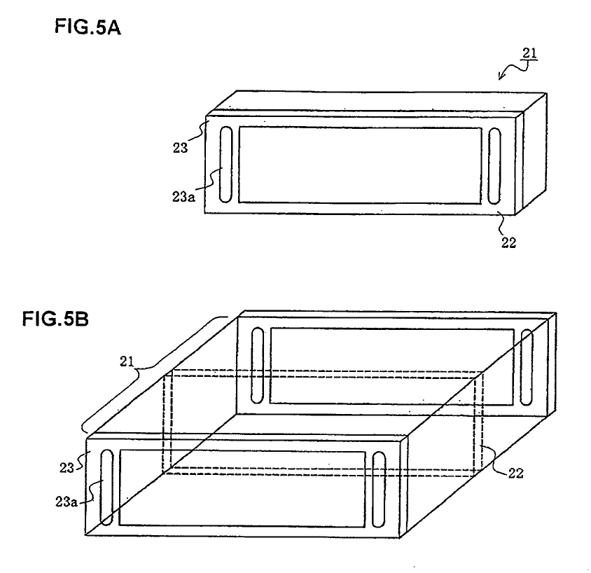

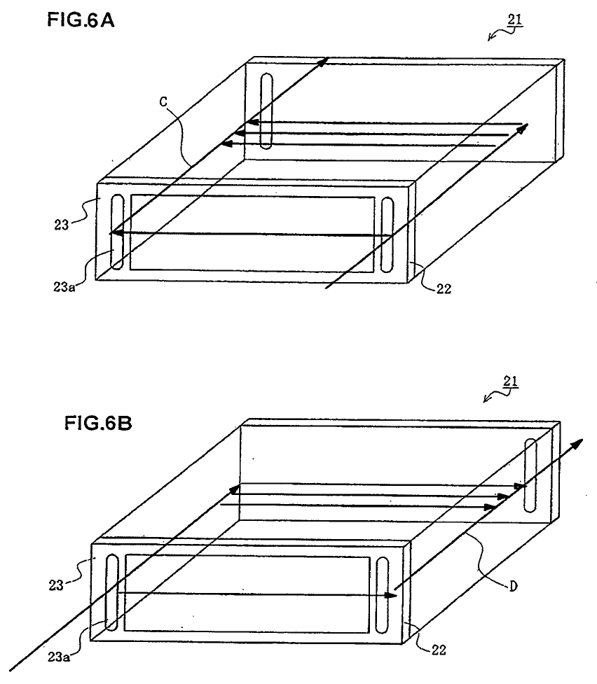

FIG. 3 is a schematic perspective view showing a structure of the fuel cell stack according to the embodiment of the present invention; FIG. 4 is a schematic top view showing the structure of the fuel cell stack according to the embodiment of the present invention; FIG. 5 shows schematic perspective views illustrating structures of cell modules according to the embodiment of the present invention; and FIG. 6 shows schematic perspective views illustrating flows of hydrogen gas in the cell modules according to the embodiment of the present invention. Note that FIG. 5A is a diagram showing an ordinary cell module; FIG. 5B is a diagram showing a cell module with a separate separator; FIG. 6A is a diagram showing the flow of hydrogen gas in the cell module in the order of an odd number; and FIG. 6B is a diagram showing the flow of hydrogen gas in the cell module in the order of an even number.

Here, explanation is made using an example in which one piece of the cell module 21 is formed by stacking ten sets of the unit cell and the separator 22 in layers and also stacking one more sheet of the separator 22 so that the separators 22 are always arranged on both sides of the unit cell, and ten pieces of the cell module 21 are stacked in layers to form one unit of the fuel cell stack 11.

In this case, the fuel cell stack 11 has a flattened rectangular parallelepiped shape as a whole, and the flow of the air inside is in the direction of gravity, that is, straight from top to bottom, as shown by arrow A in FIG. 3. In addition, as shown by arrows B in FIGS. 3 and 4, the flow of the hydrogen gas is in the direction of gravity, that is, in a serpentine or meandering shape turning around at the end of each cell module 21 in the horizontal plane substantially perpendicular to the arrow A. Note that in FIG. 4, reference numeral 15a denotes an end plate arranged on the inlet side of the hydrogen gas (lower side of FIG. 4), whereas reference numeral 15b denotes an end plate arranged on the outlet side (upper side of FIG. 4). The end plate 15a and the end plate 15b are connected with each other with a force to tighten the cell modules 21 applied by a tightening shaft, which is not shown.

In addition, each cell module 21 has a rectangular parallelepiped shape as a whole, as shown in FIG. 5A, and includes eleven sheets of the separator 22, as described above. Note that the separator 22 has a box-shaped frame portion 23 enclosing the circumference of a rectangular opening and long holes 23a formed in the vicinity of both longitudinal ends. As shown in FIG. 5A, the separators 22 closely contact each other and are stacked in layers so that the long holes 23a are arranged in line with each other, thus allowing the long holes 23a to form the hydrogen gas flow path penetrating in the direction of stacking of the separators 22. Note that FIG. 5B shows the cell module 21 in the state in which the separators 22 are spaced with each other, that is in the disassembled state, for explanatory purposes.

Here, the flow of the hydrogen gas in the cell module 21 in the order of an odd number counted from the top in FIG. 4 is as shown by arrow C in FIG. 6A. In this case, it is understood that the hydrogen gas flows through two paths that are formed by the long holes 23a arranged in lines on the right and left sides, and through ten hydrogen gas flow paths that are formed so as to connect the right and left long holes 23a on the fuel electrode sides of the separators 22. In addition, the flow of the hydrogen gas in the cell module 21 in the order of an even number counted from the top in FIG. 4 is as shown by arrow D in FIG. 6B. In this case, it is understood that, in the same way as the flow in the cell module 21 in the order of an odd number, the hydrogen gas flows through two paths that are formed by the long holes 23a arranged in lines on the right and left sides, and through ten hydrogen gas flow paths that are formed so as to connect the right and left long holes 23a on the fuel electrode sides of the separators 22.

Next, the hydrogen gas flow path on the fuel electrode side of the separator 22 will be described below.

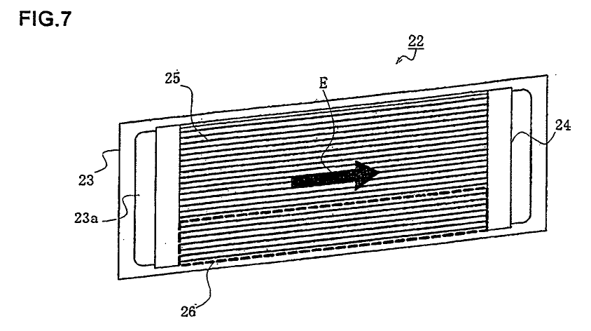

FIG. 7 is a diagram showing the hydrogen gas flow path on the fuel electrode side of the separator according to the embodiment of the present invention.

As shown in the figure, the separator 22 has a main body 25 of rectangular plate shape that is arranged in the opening of the frame portion 23 and supported by the frame portion 23, and a plate-shaped outer circumferential reinforcing plate 24 that is provided with a rectangular opening and attached to adhere to the circumference of the main body 25. Here, the hydrogen gas flows substantially perpendicularly to the direction of gravity as shown by arrow E. Moreover, the main body 25 has a function as a collector, as well as a function to shut off the hydrogen gas supplied to the fuel electrode and the air supplied to the oxygen electrode by separating the hydrogen gas flow path from the air flow path, and is a plate-shaped member made of a material with a low electric resistance, such as carbon or metal. Note that illustrations of the fuel electrode side collector and the air electrode side collector are omitted. Note also that the circumferential reinforcing plate 24 functions also as a seal member for preventing the hydrogen gas from leaking, and can be omitted if any other member can prevent the leak of the hydrogen gas.

Then, the water that has penetrated as the back-diffusing water to reach the fuel chamber of the fuel electrode side collector moves downward in the hydrogen gas flow path by its own weight, that is, by the action of gravity. Therefore, if the amount of the back-diffusing water increases, resulting in an increase of water in the hydrogen gas flow path, surplus water accumulates in the lower part in the hydrogen gas flow path to generate a water-accumulating portion 26. The water-accumulating portion 26 is a strip-shaped area extending in the direction parallel to that of the hydrogen gas flow.

Normally, in the water-accumulating portion 26, because the fuel electrode is covered locally, or even entirely, by water, the fuel electrode is made to have a smaller area for contacting the hydrogen gas to generate an electrochemical reaction. In addition, because the hydrogen gas remains in the hydrogen gas flow path more easily due to prevention of the hydrogen gas flow by the water, the remaining hydrogen mixes with the air at start or stop of the fuel cell stack 11, generating an abnormal reaction such as a potential shift, resulting in degradation of the fuel electrode.

Therefore, in the present embodiment, a portion of the fuel electrode corresponding to the water-accumulating portion 26 is provided so as not to be formed with the catalyst layer 32, thus enabling sure prevention of the occurrence of the abnormal reaction and degradation of the fuel electrode. In addition, it is desirable to prevent base material of the electrode diffusion layer 33 from soaking up the water accumulated in the water-accumulating portion 26, by giving water repellency to the electrode diffusion layer 33 in the part not formed with the catalyst layer 32.

Next, a structure of the fuel electrode of the present embodiment will be described in detail below. Here, because the air electrode and the fuel electrode are made to have the same structure as each other, the air electrode and the fuel electrode are described in a unified manner as the reaction electrode 34.

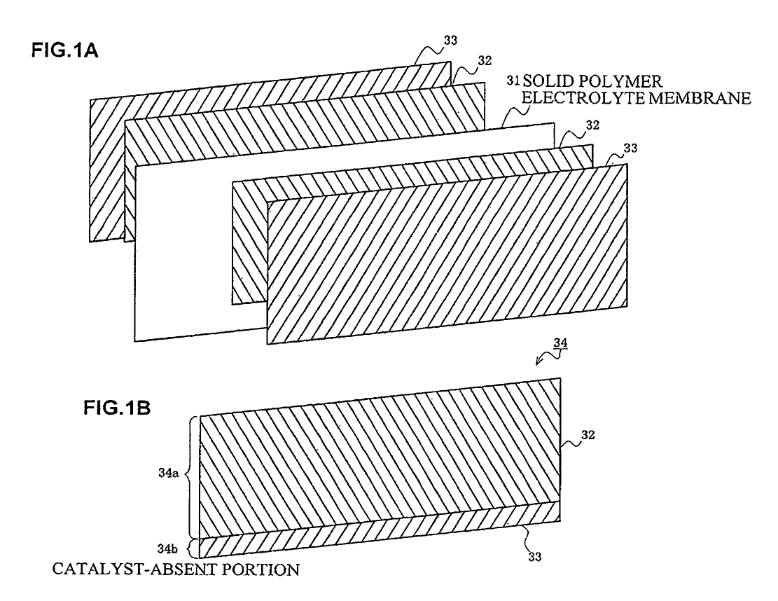

FIG. 1 shows perspective views of the reaction electrodes of the unit cell according to the embodiment of the present invention. Note that FIG. 1A is an exploded view showing the entire unit cell, and FIG. 1B is a view showing only one of the reaction electrodes.

As shown in FIG. 1A, the unit cell is composed of the solid polymer electrolyte membrane 31, and also of pairs of the catalyst layers 32 and the electrode diffusion layers 33, each pair of which form the reaction electrode 34 on each of the both sides of the solid polymer electrolyte membrane 31. Here, the solid polymer electrolyte membrane 31 is made of, for example, perfluorinated sulfonic acid polymer, which is sold under the trade name of Nafion®; however, it may be made of any material. In addition, the catalyst layers 32 is made of, for example, a catalyst in which fine particles such as platinum or ruthenium particles serving as a catalytic substance are supported on the surface of carbon particles; however, it may be made of any material. Furthermore, the electrode diffusion layers 33 use, for example, cloth or paper as a base material; however, it may be made of any material. Then, the solid polymer electrolyte membrane 31, the catalyst layers 32, and the electrode diffusion layers 33 are stacked in layers so as to be arranged in the order shown in FIG. 1A, and made closely contact each other to form a unit, thus enabling to obtain a unit cell.

In the present embodiment, as shown in FIG. 1B, the reaction electrode 34 formed by stacking the catalyst layer 32 and the electrode diffusion layer 33 has a catalyst-present portion 34a and a catalyst-absent portion 34b as a portion below the catalyst-present portion 34a, in which the catalyst layer 32 is not formed and therefore catalyst is not included. The catalyst-absent portion 34b is a portion corresponding to the above-described water-accumulating portion 26, and is a strip-shaped area extending in the lateral direction, that is, in the direction parallel to that of the hydrogen gas flow. Note that although the catalyst-absent portion 34b does not contribute to electrochemical reaction due to absence of the catalyst layer 32, the portion cannot be omitted because the surface of the electrode diffusion layer 33 on the opposite side of the solid polymer electrolyte membrane 31 (on the far side in FIG. 1B) contacts the separator 22 that has a function as a collector, and also has a function to form the hydrogen gas flow path or the air flow path between the surface and the separator 22.

Moreover, because the catalyst-absent portion 34b contacts the water accumulated in the water-accumulating portion 26 in the hydrogen gas flow path, the base material of the electrode diffusion layer 33 in the portion corresponding to the catalyst-absent portion 34b soaks up the water. Therefore, in order to prevent the water accumulated in the water-accumulating portion 26 from rising, it is desirable to give water repellency to the electrode diffusion layer 33 in the portion corresponding to the catalyst-absent portion 34b.

Next, a method for manufacturing the unit cell will be described below.

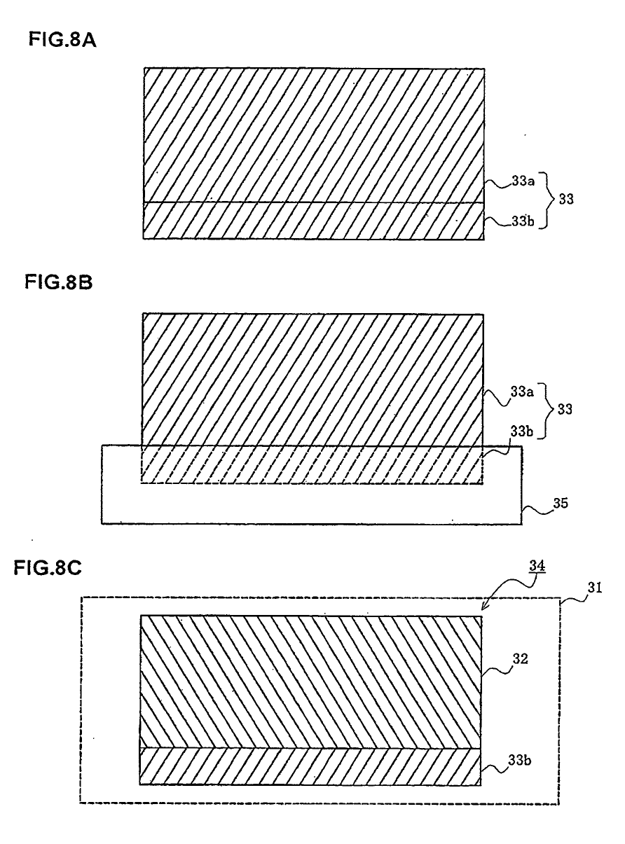

FIG. 8 shows diagrams illustrating a method for manufacturing the unit cell according to the embodiment of the present invention.

First, as shown in FIG. 8A, the electrode diffusion layer 33 composed of a normal portion 33a and a water-repellent portion 33b is formed. The normal portion 33a is a portion corresponding to the catalyst-present portion 34a, and the water-repellent portion 33b is a portion corresponding to the catalyst-absent portion 34b, which has water repellency. The water-repellent portion 33b can be formed, for example, with a water-repellent base material, or by attaching a water-repellent substance such as polytetrafluoroethylene (PTFE); however, it may be formed by any method.

Then, as shown in FIG. 8B, the water-repellent portion 33b is covered by a mask member 35 on the surface of the electrode diffusion layer 33 on the side of the solid polymer electrolyte membrane 31 (on the near side in FIG. 8B), and a material forming the catalyst layer 32 is applied on the normal portion 33a. That is, the catalyst layer 32 can be formed by masking. By this, the reaction electrode 34 having the catalyst-present portion 34a and the strip-shaped catalyst-absent portion 34b is formed, as shown in FIG. 1B.

Then, as shown in FIG. 8C, the solid polymer electrolyte membrane 31 and the reaction electrode 34 are stacked in layers so that one sheet of the solid polymer electrolyte membrane 31 is sandwiched on its both sides between two sheets of the reaction electrode 34, and are bonded by thermocompression in a unit body. In this case, each reaction electrode 34 is stacked so that the surface thereof on which the catalyst layer 32 is formed opposes the solid polymer electrolyte membrane 31. By this, the unit cell is manufactured.

As described above, in the present embodiment, the fuel cell stack 11 is made so that the portion of the reaction electrode 34 corresponding to the water-accumulating portion 26 in the fuel gas flow path is made to be the catalyst-absent portion 34b, in which the catalyst layer 32 is not formed. In the portion of the reaction electrode 34 corresponding to the water-accumulating portion 26, no abnormal reaction occurs, so that degradation of the fuel electrode can be surely prevented.

In addition, the portion of the electrode diffusion layer 33 corresponding to the catalyst-absent portion 34b is made to be the water-repellent portion 33b, which has water repellency. Therefore, the portion of the electrode diffusion layer 33 corresponding to the catalyst-absent portion 34b does not soak up water, thus enabling prevention of the water accumulated in the water-accumulating portion 26 from rising.

Note that the present invention is not limited to the embodiment described above, and various modifications based on the purpose of the present invention are possible without being excluded from the scope of the present invention.

### INDUSTRIAL APPLICABILITY

The present invention can be applied to a fuel cell device.

1. A fuel cell device provided with a fuel cell having an electrolyte layer interposed between a fuel electrode and an oxygen electrode, the fuel cell comprising a cell module laminated so as to interpose a separator formed with a fuel gas flow path along the fuel electrode, in which a fuel gas flows substantially perpendicularly to the direction of gravity in the fuel gas flow path; characterized in that
the fuel electrode comprises a catalyst-absent portion which contains no catalyst, provided in a portion corresponding to a water-accumulating portion in which water is accumulated, in the fuel gas flow path.

2. The fuel cell device according to claim 1, wherein
the water-accumulating portion is an area originating at a lower part in the fuel gas flow path and extending in the direction in which the fuel gas flows.

3. The fuel cell device according to claim 1, wherein
the catalyst-absent portion has water repellency.
